(19) United States
(12) Patent Application Publication
(10) Pub. No.: US 2015/0014450 A1
(43) Pub. Date: Jan. 15, 2015

(54) MOBILE PRESSURE WASHER WAND HOLDER

(71) Applicant: Stephen M. Suden, Jacksonville, NC (US)

(72) Inventor: Stephen M. Suden, Jacksonville, NC (US)

(21) Appl. No.: 13/938,922

(22) Filed: Jul. 10, 2013

(51) Int. Cl. B05B 15/06; B05B 9/04

(52) U.S. Cl. CPC B05B 15/06; B05B 9/04
USPC 239/722

(57) ABSTRACT

A mobile pressure washer wand holder for securely holding the wand of a pressure washer which provide physical assistance in holding the wand while allowing for more consistent and effective cleaning. The pressure washer wand holder comprises a hollow base structure mounted on two weighted plastic, and a wand holding clamp securely attached to the top of the base structure. The hollow base structure is configured to be filled with liquid prior to be operated so as to increase the weight so that it, in addition to the wheels, can effectively counteract the upward force created by the spraying of pressurized water. The wheels allow the base structure with any wand being held to be moved. The clamp is configured to receive the wand, provide for it to be locked in place, and hold it securely at a 45 degree angle relative to the surface below the base structure.

### BACKGROUND OF THE INVENTION

1. Field of the Invention

This invention relates generally to a cleaning device accessory and, more particularly, to a wheeled apparatus for holding the wand of a pressure washer which provides physical assistance in holding the wand and allows for improved consistency in surface cleaning.

2. Description of the Prior Art

The structure and function of a conventional pressure washer (or powerwasher) is well known. At a basic level, a pressure washer takes water from a water source, pressurizes it through the use of a motor or engine driven pump, and directs the pressurized water to through high pressure tubing to an output structure, typically a wand, from which the pressurized water can be selectively sprayed by a user. Wands often comprise an elongated structure having a trigger style switch which can turn on, off and otherwise control the spraying of water and a nozzle which can control or otherwise effect characteristics of the water being emitted such as the plane or pattern of the water, the flow rate, and the output pressure. Wands are commonly adapted to be held by a user, as it is generally understood that such is necessary for controlling the spraying direction and angle relative to as well as distance from surface so that the spray is accurate, consistent, and otherwise optimized for the given job.

An issue which exists, however, is that holding a wand as it continuously sprays pressurized liquid often requires the constant physical exertion to control the wand in opposition of the reflexive force generated by the pressurized water exiting the wand. Such constant exertion often results in a user straining to control the wand, and doing so for extended periods of time. Consequently, a common problem which exists is pressurized cleaning with a conventional pressure cleaning device can lead to back, arm or shoulder pain and other physical problems in those areas. Moreover, it is understood that a person already dealing with physical ailments in those areas of the body is often unable to use a conventional pressure cleaning device to perform pressure cleaning.

Thus, there is a need for an apparatus which can attach to and securely hold a wand of a conventional pressure cleaning device in a manner which reduces or eliminates physical strain for controlling the wand. It would be necessary for such an apparatus to be able to oppose the reflexive force generated by the pressurized water exiting the wand being held, while still allowing the wand to be effortlessly moved around the area being cleaned. It would be additionally desirable for such an apparatus to hold the wand in place at a distance from and angle relative to the surface to be cleaned in a manner which would grant optimal and consistent cleaning power.

The Applicant's invention described herein provides for a wheeled holding apparatus adapted to securely hold the wand of a pressure washer and provide physical assistance in holding the wand while allowing for improved surface cleaning. The primary components of Applicant's wheeled holding apparatus are a hollow base structure mounted on two weighted plastic wheels and having a wand holding clamp. When in operation, the wheeled holding apparatus securely holds the wand of a pressure washer device as it sprays pressurized liquid in accordance with its ordinary operation and allows the same to be effortlessly moved around. In this manner, it provides a method of utilizing a conventional pressure washer device which reduces the strain on the user typically associated with the same. As a result, many of the limitations imposed by the operation of conventional pressure washers are removed.

### SUMMARY OF THE INVENTION

A mobile pressure washer wand holder for securely holding the wand of a pressure washer which provides physical assistance in holding the wand while allowing for more consistent and effective cleaning. The pressure washer wand holder comprises a hollow base structure, one weighted plastic wheel attached to each side of the base and connected to each other by an axel which runs through the base structure, and a wand holding clamp securely attached to the top of the base structure. The hollow base structure is configured to be filled with liquid prior to be operated, and thus includes an aperture on its top surface and a corresponding removable cap sized and structured to provide a removable water tight cover for the aperture. The wheels allow the base structure with any wand being held to be moved. The clamp is configured to receive the wand, provide for it to be locked in place, and hold it securely at a 45 degree angle relative to the surface below the base structure. In this manner, the mobile pressure washer wand holder allows a wand of a conventional power cleaning device to be held and moved in a way that reduces strain on the operator and promotes optimal and consistent cleaning for the water spraying from wand.

The mobile pressure washer wand holder is operated by first filling the hollow base with a liquid, typically water, to provide added weight to the mobile pressure washer wand holder. Indeed, it is this added weight, along with that of the weighted wheels, which allows the mobile pressure washer wand holder to be able to oppose the reflexive force generated by the pressurized water exiting the wand being held. Then, a wand from a conventional pressure washer device is locked into the wand holder. Once the pressure washer apparatus is turned on and water spraying is actuated, the desired to the mobile pressure washer wand holder holds the wand at a 45 degree angle so that the water is sprayed at that angle, counteracts the upward force created by the spraying of pressurized water, and assists the user in moving the wand around on the surface below.

It is an object of this invention to provide an apparatus which can attach to and securely hold a wand of a conventional pressure cleaning device in a manner which reduces or eliminates physical strain for controlling the wand.

It is another object of this invention to provide an apparatus which is able to oppose the reflexive force generated by the pressurized water exiting the wand being held, while still allowing the wand to be effortlessly moved around the area being cleaned.

It is yet another object of this invention to provide an apparatus which holds the wand in place at a distance from and angle relative to the surface to be cleaned in a manner which would grant optimal and consistent cleaning power.

These and other objects will be apparent to one of skill in the art.

### BRIEF DESCRIPTION OF THE DRAWINGS

FIG. 1 is a front elevational view of a mobile pressure washer wand holder built in accordance with the preferred embodiment of the present invention.

FIG. 2 is a side elevational view of a mobile pressure washer wand holder built in accordance with the preferred embodiment of the present invention with a wand of a conventional water pressure cleaning device shown in cross section.

### DETAILED DESCRIPTION OF THE INVENTION

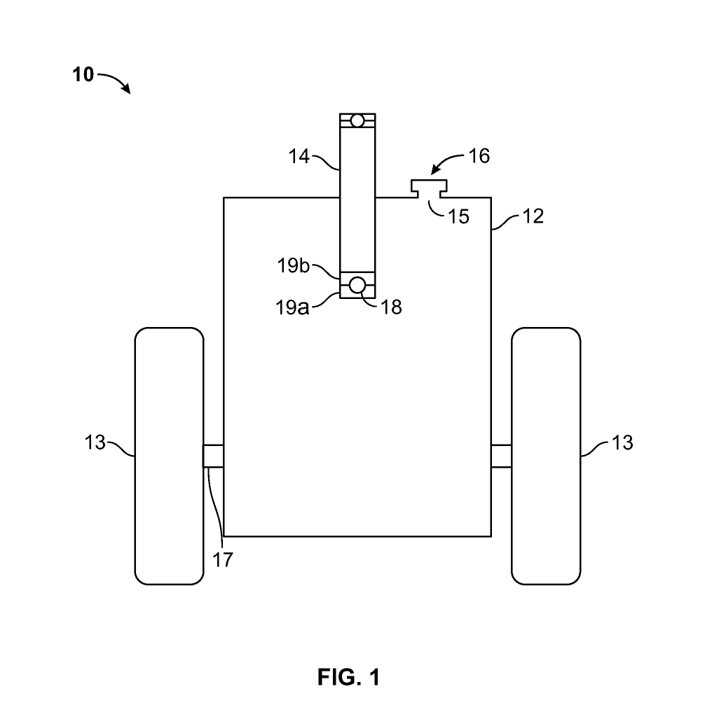

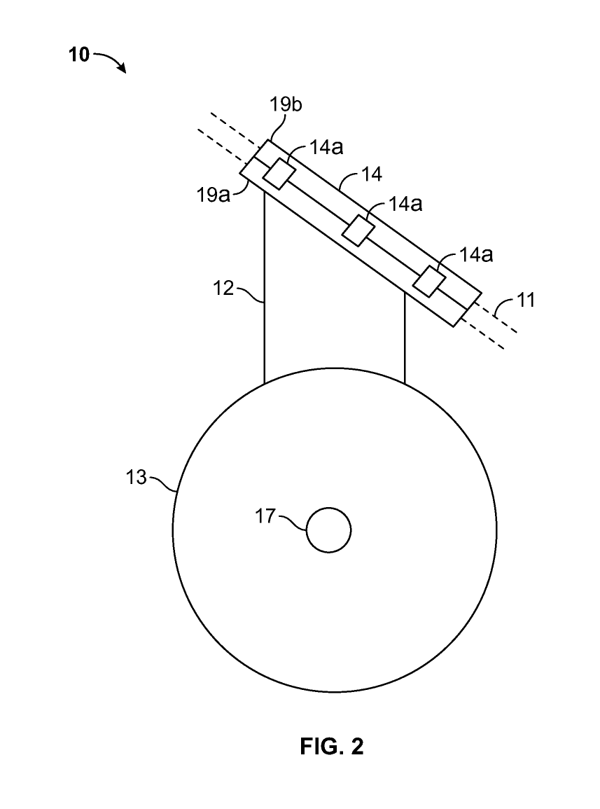

Referring now to the drawings and in particular FIGS. 1 and 2, a mobile pressure washer wand holder 10 for holding the wand 11 of a conventional water pressure cleaning device is shown comprising a rigid, rectangular body 12 mounted on two wheels 12 and having a wand holding clamp 14 permanently attached to its slanted top surface. The rectangular body 12 is a substantially hollow structure having an aperture 15 in its top surface configured to allow liquid to be placed in or removed from the inside of the hollow structure. A corresponding removable cap 16 is sized and structured to provide a removable water tight cover for the aperture 15. In this manner, the rectangular body 12 provides a structural body means for selectively adding weight as a user can fill it with water by removing the removable cap 16, introducing a water flow into the aperture 15 until the desired amount of water is in the rectangular body 12, and replacing the removable cap 16. When the user desires to empty the rectangular body 12, the removable cap 16 is removed, the water is emptied through the aperture by pouring or siphon, and the removable cap 16 can be replaced for storage.

The rectangular body 12 is mounted on two wheels 13, which are of a substantially solid construction so as provide additional weight to the mobile pressure washer wand holder 10. The wheels 13 are each connected to opposing ends of an axel which passes through a tube like passage through the rectangular body 12 such that the axel does not enter and is not otherwise exposed to the inside hollow portion of the rectangular body 12. The passage through the rectangular body is sized to allow the axel 17 to pass through but be firmly held in place when in position. The wheels 13 engage the axel 17 in a manner which allows them to rotate freely about the center axis created at the respective wheel's point of engagement with the axel 17. As a result, the wheels 13 and axel 17 provide a rolling means for moving the mobile pressure washer wand holder 10.

The wand holding clamp 14 is configured to hold a wand 11 in between a first elongated holding block 19a and a mirror image second elongated holding block 19b (collectively 19), each shaped as a substantially rectangular block having a semi circular channel on one side and held together with three permanent fasteners on a first side and three selectively engaging fasteners on a second side. In the preferred embodiment, the blocks 19 are attached together on a first side with a series of hinges and on the second side with a series of latches 14a. This construction allows them to swing together by way of the hinges and lock by way of the latches 14a to form a closed circular channel 18 adapted to fit and hold a wand 11 and to unlock and swing apart to allow the insertion or removal of the wand 11. Together, the blocks 19 provide a clamping means for holding a wand 11.

In operation, the rectangular base 12 of mobile pressure washer wand holder 10 is first filled with a water so as to provide the added weight necessary to oppose the reflexive force generated by the pressurized water exiting a wand 11 being operated. Then, the latches 14a on the holding clamp 14 are disengaged, allowing the second elongated block 19b to be swung open and a wand 11 from a conventional pressure washer device to be inserted. Once the wand 11 is in place, the second elongated block 19b is swung back over to fully engage the first elongated block 19a, trapping the wand in the channel 18, and the latches 14a are locked to secure the wand 11 in the holding clamp 14. At this point, as the pressure cleaning device is turned on and water spraying actuated, the mobile pressure washer wand holder 10 holds the wand 11 at a 45 degree angle relative to the surface on which the mobile pressure washer wand holder 10 is disposed and the user can roll the mobile pressure washer wand holder 10 around, typically by guiding the wand 11, to allow the water spray to perform its cleaning action. As the weight of the rectangular body 12 and wheels counteracts the upward force on the wand 11 generated by the pressurized water spraying, the user is relieved of the strain such force would create if the user attempted to hold the wand manually.

In an alternate embodiment, a handle is additionally attached to the top surface of the rectangular body so as to provide a handling means for balancing and moving the mobile pressure washer wand holder 10.

In another alternate embodiment, the rectangular body is mounted on four wheels.

In yet another alternate embodiment, the rectangular body is disposed on top of the axel of the wheels.

In still another alternate embodiment, the wheels individually connected to the rectangular body and not an axel.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A pressure washer wand holder comprising:
a rigid hollow base body;
two wheels, wherein said base body is mounted on said wheels; and
a wand holding clamp securely attached to the top of the base body, wherein said clamp is adapted to receive and hold a wand configured to be handled by a user of a water pressure cleaning device.

2. The pressure washer wand holder of claim 1, wherein the wheels are connected by single axel.

3. The pressure washer wand holder of claim 2, wherein:
the base body includes a tube like passageway which passes from one side of the base body to the other side; and
said axel passes through said passageway in such a manner that it does not enter and is not otherwise exposed to the hollow inside of the base body.

4. The pressure washer wand holder of claim 1, wherein said base body is mounted on said wheels such that the wheels are disposed on opposing sides of the base body.

5. The pressure washer wand holder of claim 1, wherein said wand holding clamp comprises two elongated holding blocks, each substantially shaped as a rectangular block having a semi circular channel on one side, wherein said holding blocks are held together with at least one permanent fastener on a first side and at least one selectively engaging fastener on a second side.

6. The pressure washer wand holder of claim 5, wherein said holding blocks are held together three latch mechanisms on the second side.

7. The pressure washer wand holder of claim 1, wherein said wand holding clamp is disposed on said base body such that it holds a wand at a 45 degree angle relative to the surface on which the pressure washer wand holder rests.

8. The pressure washer wand holder of claim 1, wherein said base body includes a slanted top surface to which said wand holding clamp is permanently attached.

9. The pressure washer wand holder of claim 1, wherein said base body is adapted to receive and hold weighted material in its hollow interior.

10. The pressure washer wand holder of claim 1, wherein said base body is adapted to receive and hold water in its hollow interior.

11. The pressure washer wand holder of claim 1, wherein said wheels are weighted.

12. A pressure washer wand holder comprising:
a structural body means for selectively adding weight;
a rolling means connected to said body means for moving the mobile pressure washer wand holder; and
a clamping means for holding a wand configured to be handled by a user of a water pressure cleaning device.

13. The pressure washer wand holder of claim 12, additionally comprising a handling means for moving the mobile pressure washer wand holder.
